(19) United States
(12) Patent Application Publication
(10) Pub. No.: US 2010/0163777 A1
(43) Pub. Date: Jul. 1, 2010

(54) MAGNETIC PARTICLES AND PROCESS FOR THEIR PRODUCTION

(75) Inventor: Kazumichi Nakahama, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANNON KABUSHIKI KAISHA

(21) Appl. No.: 12/377,661

(22) PCT Filed: Aug. 8, 2007
(86) PCT No.: PCT/JP2007/065881

§ 371 Date: Feb. 16, 2009

(30) Foreign Application Priority Data
Aug. 31, 2006 (JP) 2006-236722

(51) Int. Cl. H01F 1/42; B32B 9/00

(52) U.S. Cl. 252/62.53; 428/402

(57) ABSTRACT

Magnetic particles containing a magnetic material and a biodegradable polymeric compound; the magnetic particles having average particle diameter in the range of from 10 nm or more to 1,000 nm or less.

### TECHNICAL FIELD

This invention relates to magnetic particles and a process for producing the same. More particularly, it relates to medical-purpose magnetic particles which are useful in the field of medicines and diagnostic pharmaceutical agents, in particular, useful as contrast media for MRI (magnetic resonance imaging) and carriers for DDS (drug delivery system).

### BACKGROUND ART

Magnetic particles are expected to have a great variety of uses, and attract notice of their use as, in particular, bases used in the field of medical treatment and diagnoses, such as medicines and diagnostic pharmaceutical agents (hereinafter such bases are called “medical-purpose magnetic particles”).

Medical-purpose magnetic particles hitherto having chiefly been developed are chiefly of extracorporeal use, and only a few reports have been made on those of intracorporeal use. However, in view of the situation of medical and diagnostic fields in recent years, it is supposed that it hereafter becomes more and more necessary to design and develop the medical-purpose magnetic particles keeping their intracorporeal use in mind.

As an example thereof, in recent years it has begun to be energetically studied to apply such medical-purpose magnetic particles to MRI contrast media, magnetic hyperthermic agents, DDS carriers and so forth.

However, in order to safely administer the medical-purpose magnetic particles intracorporeally and bring out their effect usefully as MRI contrast media, magnetic hyperthermic agents or DDS carriers, it is necessary to make them into preparations considering various points such as toxicity to living organisms, stability, and providing target directionality to the affected part.

For example, materials constituting the medical-purpose magnetic particles are severely restricted from the viewpoint of toxicity to living organisms and adaptability to living organisms. Hence, this makes it much more difficult to develop the medical-purpose magnetic particles.

Considering the matter in view of the toxicity to living organisms, it is essential for such materials to have a very small possibility of damaging functions of living organisms, e.g., causing allergies, cancers, and endocrine disruption. In addition, it is preferable for such materials to be extracorporeally metabolized after they have completed bringing out the functions as the medical-purpose magnetic particles.

Considering the matter in view of the adaptability to living organisms, the medical-purpose magnetic particles are foreign matter to living organisms and hence have a possibility of, e.g., causing platelet aggregation to affect living organisms adversely.

Journal of Chemical Engineering of Japan, 34 (1), pp. 66-72, 2001 discloses the following:

That is, it discloses an MRI contrasting effect of a magnetoliposome in which fine magnetite particles are enclosed in a liposome composed of lipid bilayers.

The lipid bilayers are substances originating from living organisms, and the magnetite is a conventionally known paramagnetic material having superior adaptability to living organisms. Accordingly, the magnetoliposome is a strong candidate for the medical-purpose magnetic particles in view of its low toxicity to living organisms. However, it leaves a problem on long-term stability in living organisms because of a weak associative force inherent in liposomes.

Meanwhile, Japanese Patent Publication No. H06-026594 discloses a particulate substance obtained by kneading polylactic acid and magnetite; the former being a sort of biodegradable polymeric compounds. This particulate substance, however, has an average particle diameter which is as relatively large as from 5 μm to 2 mm. Hence, it is difficult to use it for the MRI contrast media or DDS carriers.

In any of the above medical-purpose magnetic particles, it is presumed that, in order to provide them with the target directionality to the affected part, it is necessary to introduce a probe and so forth separately by an organic chemical measure. However, taking such an organic chemical measure is undesirable because there is a possibility of causing a new toxicity to living organisms.

For the reasons stated above, it has been sought to develop medical-purpose magnetic particles having the stability and the target directionality to the affected part and having a low toxicity to living organisms.

### DISCLOSURE OF THE INVENTION

The present invention has been made taking account of such background art. Accordingly, an object of the present invention is to provide magnetic particles having a good size uniformity and a high safety, and a process for producing the same.

The present inventor has discovered magnetic particles of nanometer in size which are constituted of a magnetic material and a biodegradable polymeric compound, and a process for producing such magnetic particles. Thus, the inventor has accomplished the present invention.

The magnetic particles provided by the present invention are magnetic particles which comprises a magnetic material and a biodegradable polymeric compound;

the magnetic particles having average particle diameter in the range of from 10 nm or more to 1,000 nm or less.

The process for producing magnetic particles which is provided by the present invention is a process having the steps of:

(1) preparing a liquid mixture containing a biodegradable polymeric compound, a magnetic material and a first solvent;

(2) preparing an emulsion by mixing the liquid mixture with a second solvent; and

(3) removing the first solvent from the emulsion by evaporation or extraction;

the magnetic particles comprising the biodegradable polymeric compound and the magnetic material, having average particle diameter in the range of from 10 nm or more to 1,000 nm or less, and having a dispersibility index of 1.5 or less.

Further features of the present invention will become apparent from the following description of exemplary embodiments with reference to the attached drawings.

### BRIEF DESCRIPTION OF THE DRAWINGS

FIG. 1 is a transmission electron microscope photograph presenting the particle structure of Magnetic Particles 1 in Example 1 of the present invention.

### BEST MODE FOR CARRYING OUT THE INVENTION

The present invention is described below in detail. The magnetic particles according to the present invention are magnetic particles which contains a magnetic material and a biodegradable polymeric compound to constitute the magnetic particles, and are characterized by having average particle diameter in the range of from 10 nm or more to 1,000 nm or less.

The magnetic particles of the present invention are utilizable as medical-purpose magnetic particles shown below and having a low toxicity to living organisms and a high safety, and having target directionality to cancer cells.

That is, the medical-purpose magnetic particles include MRI contrast media (the magnetic particles shorten relaxation time in nuclear magnetic resonance to make MRI images sharp) and magnetic hyperthermic agents (used in local hyperthermic treatment by utilizing the property that the magnetic particles generates heat in the presence of electromagnetic waves). In addition, the medical-purpose magnetic particles include DDS carriers (by which magnetic particles enclosing a medicine are transported to any desired portions in living organisms by magnetic operation).

As the biodegradable polymeric compound in the present invention, any substance may be used as long as it is a biodegradable high polymer which can achieve what is aimed in the present invention. As examples, it may include the following:

Polyesters as exemplified by homopolymers of α-hydroxy acids (for example, glycolic acid, lactic acid, hydroxyalkanoic acids, 2-hydroxybutyric acid, 2-hydroxyvaleric acid, 2-hydroxy-3-methylbutyric acid, 2-hydroxycaproic acid, 2-hydroxyisocaproic acid and 2-hydroxycapric acid), cyclic dimers of α-hydroxy acids (for example, glycollide and lactides), hydroxydicarboxylic acids (for example, malic acid) or hydroxytricarboxylic acids (for example, citric acid), as exemplified by poly(lactic acid), poly(glycolic acid) and poly(hydroxyalkanoic acids); copolymers of two or more of any of these, as exemplified by a lactic acid/glycolic acid copolymer and a 2-hydroxybutyric acid/glycolic acid copolymer; and mixtures of any of these homopolymers and/or copolymers, as exemplified by a mixture of a lactic acid polymer with a 2-hydroxybutyric acid/glycolic acid copolymer;

polyglycosides as exemplified by hyaluronic acid, alginic acid, chondroitin sulfate, chitin, chitosan and oxycellulose; and

polyamino acids as exemplified by poly-L-glutamic acid, poly-L-alanine and poly-γ-methyl-L-glutamic acid.

Of these, polyesters are preferred. In particular, aliphatic polyesters are preferred.

Of the aliphatic polyesters, polymers or copolymers synthesized from at least one of α-hydroxycarboxylic acids including:

α-hydroxymonocarboxylic acids as exemplified by glycolic acid, lactic acid and hydroxyalkanoic acids;

α-hydroxydicarboxylic acids as exemplified by malic acid; and

α-hydroxytricarboxylic acids as exemplified by citric acid;

and having free terminal carboxylic groups; or mixtures of any of these may preferably be used. This is preferable in view of low toxicity, biodegradability, and adaptability to living organisms.

In the case of the copolymers, the form of combination of monomers may be any of random, block and graft combinations.

Where the above α-hydroxymonocarboxylic acids, α-hydroxydicarboxylic acids and α-hydroxytricarboxylic acids have optically active centers in their molecules, they may be of any of D-, L- and DL-configurations.

As the magnetic material in the present invention, any magnetic material may be used as long as what is aimed in the present invention can be achieved. In particular, it is preferable to use ultrafine magnetic-material particles containing a metallic atom. The ultrafine magnetic-material particles may be in the form of metal oxides.

As specific examples of such ultrafine magnetic-material particles, they may include the following:

Ultrafine particles of various ferrites such as gadolinium oxide, magnetite, maghematite, Mn—Zn ferrite, Ni—Zn ferrite, Y—Fe garnet, Ga—Fe garnet, Ba ferrite and Sr ferrite; metals such as iron, manganese, cobalt, nickel, chromium and gadolinium; and alloys of at least two of iron, manganese, cobalt, nickel and gadolinium.

It is more preferable to use magnetite or maghematite as having a superior adaptability to living organisms. Such magnetic materials may also be those having been treated with a known hydrophobic-treating agent such as a titanium coupling agent, a silane coupling agent or a higher fatty acid.

Here, the term “ultrafine particles” in the ultrafine magnetic-material particles refers to fine particles having a size of not more than submicron order.

The magnetic particles in the present invention contain the biodegradable polymeric compound and the magnetic material to constitute the magnetic particles.

As to the amount of the magnetic material to be contained in the magnetic particles, there are no limitations thereon as long as what is aimed in the present invention can be achieved. It may preferably be contained in an amount of from 1% by mass or more to 80% by mass or less, more preferably from 51% by mass or more to 70% by mass or less, and further, particularly preferably from 51% by mass or more to 60% by mass or less.

If the magnetic material is contained in the magnetic particles in an amount of less than 1% by mass, it can not bring out its function as the magnetic material, undesirably. If it is in an amount of more than 80% by mass, it can not bring out the function of the biodegradable polymeric compound, undesirably.

Further, as the magnetic material to be contained in the magnetic particles in the present invention, a magnetic material having any average particle diameter may be used as long as what is aimed in the present invention can be achieved.

The optimum average particle diameter of the magnetic material differs depending on what purposes the magnetic particles are used for.

In the case of magnetic particles intended for the passive targeting to cancer cells that utilizes the EPR (enhanced permeability and retention) effect as described later, the magnetic material may preferably have an average particle diameter of 50 nm or less in order to provide the magnetic particles with uniform properties.

The magnetic material may more preferably have an average particle diameter of 40 nm or less, and still more preferably 30 nm or less or 20 nm or less. Such a magnetic material is particularly favorable.

However, if the magnetic material has an average particle diameter of 1 nm or less, such a magnetic material has a small heat generation efficiency under application of an external alternating magnetic field, and hence it is difficult for the resultant magnetic particles to be used as the magnetic hyperthermic agents. The magnetic material contained in the magnetic particles may preferably uniformly be dispersed in the magnetic particles, making the biodegradable polymeric compound serve as a binder.

The magnetic particles in the present invention may preferably have an average particle diameter of from 10 nm or more to 1,000 nm or less.

Fine particles having an average particle diameter of 1,000 nm or less are in such a size that they are readily phagocytized by, e.g., phagocytes floating in blood, and hence may preferably be used as DDS carriers intended for cell delivery.

Further, where the magnetic particles of the present invention are used as DDS carriers of a type that they are intracorporeally taken in through mucous membranes, it is more favorable that the magnetic particles have an average particle diameter of 200 nm or less, preferably 150 nm or less, and also more preferably 100 nm or less.

Where the magnetic particles of the present invention are used as medical-purpose magnetic particles such as the MRI contrast media, magnetic hyperthermic agents and DDS carriers that acts specifically on cancer cells, it is more favorable that the magnetic particles have an average particle diameter of 100 nm or less, preferably 80 nm or less, and also more preferably about 50 nm.

In general, where solid cancer has come about in living organisms, tumor neogenesis vessels for supplying nutrition and oxygen to the cancer cells are known to be formed in order for the solid cancer to support itself and grow in living organisms. Such tumor neogenesis vessels are brittle and stand enhancively permeable, and hence particulate substances of 100 nm or less in size, preferably granular substances of about 80 nm or less or further about 50 nm in size, accumulate passively at tumor interstices.

Such a phenomenon is called the EPR effect. The magnetic particles of the present invention utilize the EPR effect, and this enables passive targeting on cancer cells.

In thinking about the passive targeting on cancer cells that utilizes the EPR effect, the monodispersity of magnetic particles is a very important physical property.

The magnetic particles in the present invention are favorable where the magnetic particles have a dispersibility index calculated from number average particle diameter (Dn) and weight average particle diameter (Dw), Dw/Dn, of 1.5 or less, preferably 1.3 or less, and more preferably 1.2 or less. Magnetic particles having a dispersibility index of more than 1.5 are undesirable because such particles may be non-uniform in their properties required as medical-purpose magnetic particles.

The magnetic particles in the present invention may further have a high true sphericity, and may preferably be made to have an average aspect ratio (length/breadth ratio) of from 1.0 or more to 1.5 or less, and more preferably from 1.0 or more to 1.2 or less. When administered intracorporeally, such truly spherical magnetic particles can effect the passive targeting on cancer cells without stagnating in, e.g., blood vessels.

The magnetic particles in the present invention may be magnetic particles on the surfaces of which a blocking agent for controlling any nonspecific adsorption has been adsorbed or combinatively held.

The nonspecific adsorption is a phenomenon that any unwanted biosubstances adsorb on the surfaces of magnetic particles when the magnetic particles are intracorporeally administered. It involves a possibility of causing undesirable bioreactions such as excess immunoreaction and platelet aggregation. The blocking agent refers to what is used at an aim of preventing such undesirable bioreactions. In the present invention, any substance may be used as the blocking agent as long as such an aim can be achieved.

The blocking agent may include, as its specific examples, hydrophilic high polymers having a good adaptability to living organisms, such as polyethylene glycol and polyethylene glycol derivatives, and also polysaccharides, lipids, and compounds having a peptide linkage.

Of these, preferably usable are compounds having a peptide linkage, in particular, polypeptides of protein; and preferably albumins such as serum albumin, ovalbumin, conalbumin and lactoalbumin, and milk proteins such as casein, casein-decomposed products and nonfat milk. These are preferable because they are low toxic to living organisms as they are substances derived from living organisms

The process for producing the magnetic particles according to the present invention is characterized by having the steps of (1) preparing a liquid mixture containing the biodegradable polymeric compound, the magnetic material and a first solvent, (2) preparing an emulsion by mixing the liquid mixture with a second solvent and (3) removing the first solvent from the emulsion by evaporation or extraction; the magnetic particles comprising the biodegradable polymeric compound and the magnetic material, having average particle diameter in the range of from 10 nm or more to 1,000 nm or less, and having a dispersibility index of 1.5 or less.

As the first solvent in the present invention, any solvent may be used as long as it is a solvent in which the biodegradable polymeric compound used in the present invention is soluble and is a solvent substantially not miscible with the second solvent (water as a specific example).

It may preferably be an organic solvent having a solubility in water, of 3% by mass or less at normal temperature (20° C.).

As examples of such a solvent, it may include the following:

Halogenated hydrocarbons such as dichloromethane, chloroform, chloroethane, dichloroethane, trichloroethane, and carbon tetrachloride;

ketones as exemplified by acetone, methyl ethyl ketone, and methyl isobutyl ketone;

ethers such as tetrahydrofuran, ethyl ether, and isobutyl ether;

esters such as ethyl acetate and butyl acetate; and

aromatic hydrocarbons such as benzene, toluene and xylene.

Any of these may be used alone or may be used in the form of a mixture of two or more types in an appropriate proportion.

The first solvent may particularly preferably be any of the halogenated hydrocarbons and aromatic hydrocarbons.

The second solvent in the present invention is a solvent not miscible with the second solvent. “Not miscible” means that the solvent is substantially not miscible, and allows to include what comes mixed in a very small quantity. The second solvent may preferably have a solubility in the first solvent, of 3% by mass or less at normal temperature (20° C.). As an example such a solvent, it may preferably be water or an aqueous solution. The second solvent may preferably be what is slightly soluble in the biodegradable polymeric compound used in the present invention.

Whether or not the polymeric compound is soluble or slightly soluble in solvents may be evaluated according to the following method.

The polymeric compound is beforehand so mixed as to be 3% by mass based on the solvent, and the mixture obtained is stirred at 25° C. for 24 hours, followed by leaving for 24 hours. Then, when the mixture is present in a uniform state, the state of being mixed is defined to be soluble; and, when the mixture is present in the state of imperfect dissolution, showing a gel-like or granular appearance or looking visibly cloudy, the state of being mixed is defined to be slightly soluble.

Note, however, that what is meant by “slightly soluble” in the present invention is an expression embracing what is called the state of being insoluble in which any solvent action on the biodegradable polymeric compound is not seen. Where it is difficult to judge the solubility by visual observation, the transmittance of a solution or dispersion in which the biodegradable polymeric compound stands dissolved or dispersed may be measured, and the resultant value may be used as an index of the solubility. In this case, in the present invention, a case in which the transmittance is 95% or more is defined to be soluble, and a case in which the transmittance is less than 95% is defined to be slightly soluble. The transmittance may be measured by a known method. In the present invention, transmittance that is found when incident light is 500 nm in wavelength is used as an evaluation standard, as measured with a U-2001 model double-beam spectrophotometer (manufactured by Hitachi Ltd).

In the process for producing the magnetic particles in the present invention, a liquid mixture constituted of the biodegradable polymeric compound, the magnetic material and the first solvent is mixed with the second solvent to prepare an emulsion.

Then, as the emulsion, an emulsion which has particles having a one-peak particle size distribution with its average particle diameter of from 20 nm or more to 5,000 nm or less and a dispersibility index of 1.5 or less is prepared as a product of intermediate state, and through this emulsion the final magnetic particles may be obtained. It is useful to do so. Such an emulsion may be prepared through the following steps.

In the process for producing the magnetic particles in the present invention, a liquid mixture constituted of the biodegradable polymeric compound, the magnetic material and the first solvent is mixed with the second solvent, and then emulsification is operated to prepare a first emulsion.

The first emulsion is a polydisperse emulsion made up of the above liquid mixture as a dispersoid and the second solvent as a dispersion medium. This first emulsion may be prepared by a conventionally known emulsification method as exemplified by intermittent shaking, stirring making use of a mixer such as a propeller mixer or a turbine impeller mixer, colloid milling, homogenizing, or ultrasonic irradiation.

Next, the first emulsion is further subjected to additional operation for emulsification to prepare a second emulsion. It is essential for the second emulsion to be an emulsion with a superior monodispersity, having a one-peak particle size distribution with its average particle diameter of from 20 nm or more to 5,000 nm or less and a dispersibility index of 1.5 or less. Taking the step through the second emulsion as a product of intermediate state enables production of magnetic particles having a superior monodispersity.

The second emulsion may be prepared by a conventionally known emulsification method. In particular, homogenizing or ultrasonic irradiation is preferred.

In the present invention, the step of preparing the first emulsion and the step of preparing the second emulsion may be carried out by one-time operation for emulsification. However, the magnetic particles having a superior monodispersity can readily be obtained when the emulsification is carried out through two-stage operation. The emulsification may also be carried out through two or more multi-stage operation as long as the present invention can effectively be practiced.

Here, in order to prepare the second emulsion, the above liquid mixture may preferably have a viscosity at 25° C. of 20 mPa·s or less. If the liquid mixture has a viscosity higher than this, it is difficult to form the second emulsion as a product of intermediate state. This has been ascertained by an experiment. More preferably, the liquid mixture may have a viscosity of 15 mPa·s or less, and still more preferably 10 mPa·s or less, where the present invention can more favorably be practiced.

The viscosity of the solution or mixture in the present invention may be evaluated by a conventionally known method. It may be measured with an existent viscometer as exemplified by VISCOMETER CONTROLLER RC-100, manufactured by Toki Sangyo Co., Ltd.

To remove the first solvent from the second emulsion, it may be removed by a conventionally known method.

As specific methods, the following methods are available.

They are a method in which the second emulsion is stirred by means of a propeller mixer or a magnetic stirrer, during which the first solvent is removed by evaporation under normal pressure or under gradually reduced pressure, and a method in which a rotary evaporator is used to remove the first solvent by evaporation under control of degree of vacuum and temperature. Besides, a method is available in which a solvent soluble in both the first solvent and the second solvent is added to remove the first solvent by extraction.

In the present invention, in the step of preparing the first emulsion or the second emulsion, a dispersing agent may be added to either of the first emulsion and the second emulsion or to both of them.

As examples of the dispersing agent, it may include the following:

Anionic surface-active agents as exemplified by sodium oleate, sodium stearate and sodium lauryl sulfate;

nonionic surface-active agents as exemplified by polyoxyethylene sorbitan fatty esters such as TWEEN 80 and TWEEN 60, available from Atlas Powder Company, U.S.A.), and polyoxyethylene caster oil derivatives such as HCO-70, HCO-60 and HCO-50, available from Nikko Chemicals Co., Ltd.; and

polyvinyl pyrrolidone, polyvinyl alcohol, carboxymethyl cellulose, lecithin, gelatin, hyaluronic acid, and derivatives of these.

Any one of these may be used or some of these may be used in combination.

The concentration of the dispersing agent is not limitative as long as the present invention can be practiced, and may be in the range of approximately from 0.01% by mass or more to 20% by mass or less, and preferably approximately from 0.05% by mass or more to 10% by mass or less.

The average particle diameters of the magnetic particles, magnetic material and emulsion in the present invention may be evaluated by a conventionally known method. The average particle diameters of the magnetic particles, magnetic material and emulsion, each standing dispersed in a medium, may preferably be measured by a dynamic light scattering method. As examples of an instrument for measuring particle diameter by the dynamic light scattering method, it includes instruments such as DLS8000, manufactured by Otsuka Electronics Co., Ltd. Where the aspect ratio of the magnetic particles and the state of dispersion of the magnetic material contained in the magnetic particles are evaluated, a transmission electron microscope may be used. Incidentally, the average particle diameter in the present invention refers to average particle diameter of each of the magnetic particles, magnetic material and emulsion each standing dispersed in a medium.

According to the present invention, it can provide magnetic particles having a good size uniformity and a high safety and a process for producing the same. According to the present invention, it can also provide medical-purpose magnetic particles having a low toxicity to living organisms and a high safety and having target directionality to cancer cells, utilizable as MRI contrast media, magnetic hyperthermic agents and DDS carriers.

### EXAMPLES

The present invention is described below in greater detail by giving working examples. The present invention is by no means limited to these working examples.

### Example 1

### Production of Magnetic Particles 1

(a) Production of Ultrafine Magnetite Particles:

FeCl₃ and FeCl₂ were dissolved in water to make up a solution. To this solution, ammonia water was added with vigorous stirring to make up a magnetite suspension. To this suspension, oleic acid was added, followed by stirring at 70° C. for 1 hour and then at 110° C. for 1 hour to make up a slurry. This slurry was washed with a large quantity of water, and then dried under reduced pressure to obtain a powdery hydrophobic magnetite. The hydrophobic magnetite thus obtained was dispersed in chloroform to make evaluation by using DLS8000 (manufactured by Otsuka Electronics Co., Ltd.) to ascertain that it had an average particle diameter of 11 nm and a dispersibility index of 1.3.

(b) Production of Magnetic Particles:

0.3 g of a polyhydroxyalkanoic acid and 0.3 g of the hydrophobic magnetite were weighed in 6 g of chloroform to prepare a liquid chloroform mixture. Meanwhile, 0.6 g of sodium dodecyl sulfate (SDS) was dissolved in water to prepare 24 g of an aqueous SDS solution. The liquid chloroform mixture and the aqueous SDS solution were mixed to make up a liquid mixture. This liquid mixture was treated by shearing for 1 hour by means of a stirring homogenizer to make up a first emulsion.

Next, the first emulsion was treated by shearing for 4 minutes by means of an ultrasonic homogenizer to prepare a second emulsion. The second emulsion was evaluated by using DLS8000 (manufactured by Otsuka Electronics Co., Ltd.) to ascertain that the second emulsion had an average particle diameter of 186 nm and a dispersibility index of 1.3.

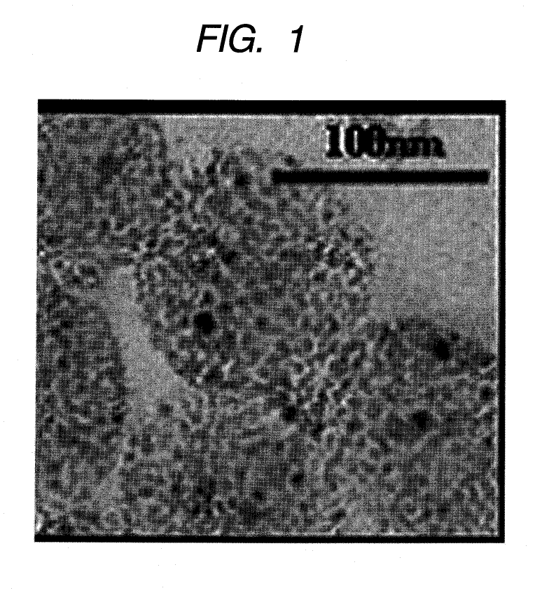

Next, the second emulsion was set under reduced pressure in an evaporator to remove the chloroform from the second emulsion by evaporation to obtain Magnetic Particles 1. Magnetic Particles 1 were evaluated by using DLS8000 (manufactured by Otsuka Electronics Co., Ltd.) to ascertain that the magnetic particles had an average particle diameter of 126 nm and a dispersibility index of 1.2. Magnetic Particles 1 were also evaluated by using a TEM (transmission electron microscope) to ascertain that magnetite was contained in the state of being dispersed. A transmission electron microscope photograph presenting the particle structure of Magnetic Particles 1 is shown in FIG. 1.

### Example 2

### Production of Magnetic Particles 2

0.2 g of poly-L-lactic acid and 0.4 g of the hydrophobic magnetite obtained in Example 1 in a powdery form were weighed in 6 g of chloroform to prepare a liquid chloroform mixture. Meanwhile, 0.57 g of sodium dodecyl sulfate (SDS) was dissolved in water to prepare 24 g of an aqueous SDS solution. The liquid chloroform mixture and the aqueous SDS solution were mixed to make up a liquid mixture. This liquid mixture was treated by shearing for 1 hour by means of a stirring homogenizer to make up a first emulsion.

Next, the first emulsion was treated by shearing for 4 minutes by means of an ultrasonic homogenizer to prepare a second emulsion. The second emulsion was evaluated by using DLS8000 (manufactured by Otsuka Electronics Co., Ltd.) to ascertain that the second emulsion had an average particle diameter of 102 nm and a dispersibility index of 1.2.

Next, to the second emulsion, ethanol was little by little dropwise added at room temperature with stirring, and then this emulsion was subjected to dialysis in the order of an aqueous 30% by mass ethanol solution, an aqueous 10% by mass ethanol solution and water to remove the chloroform from the second emulsion by extraction to obtain Magnetic Particles 2.

Magnetic Particles 2 were evaluated by using DLS8000 (manufactured by Otsuka Electronics Co., Ltd.) to ascertain that the magnetic particles had an average particle diameter of 52 nm and a dispersibility index of 1.1. Magnetic Particles 2 were also evaluated by using a TEM to ascertain that magnetite was contained in the state of being dispersed.

### Example 3

### Production of Magnetic Particles 3

0.4 g of a lactic acid/glycolic acid copolymer and 0.2 g of the hydrophobic magnetite obtained in Example 1 were weighed in 0.6 g of chloroform to prepare a liquid chloroform mixture. Meanwhile, 0.57 g of sodium dodecyl sulfate (SDS) was dissolved in water to prepare 24 g of an aqueous SDS solution. The liquid chloroform mixture and the aqueous SDS solution were mixed to make up a liquid mixture. This liquid mixture was treated by shearing for 1 hour by means of a stirring homogenizer to make up a first emulsion.

Next, the first emulsion was treated by shearing for 4 minutes by means of an ultrasonic homogenizer to prepare a second emulsion. The second emulsion was evaluated by using DLS8000 (manufactured by Otsuka Electronics Co., Ltd.) to ascertain that the second emulsion had an average particle diameter of 205 nm and a dispersibility index of 1.2.

Next, the second emulsion was set under reduced pressure in an evaporator to remove the chloroform from the second emulsion by evaporation to obtain Magnetic Particles 3. Magnetic Particles 3 were evaluated by using DLS8000 (manufactured by Otsuka Electronics Co., Ltd.) to ascertain that the magnetic particles had an average particle diameter of 153 nm and a dispersibility index of 1.2. Magnetic Particles 3 were also evaluated by using a TEM to ascertain that magnetite was contained in the state of being dispersed.

### Example 4

### Production of Magnetic Particles 4

Magnetic Particles 2 dispersed in an aqueous SDS solution and an albumin solution prepared by dissolving albumin in a phosphate buffer (pH 7.4) were mixed, and then the mixture obtained was subjected to dialysis with the phosphate buffer to make the albumin adsorbed on the surfaces of Magnetic Particles 2 to produce Magnetic Particles 4. Magnetic Particles 4 were settled by centrifugation, and the concentration of the albumin of the supernatant liquid was measured to ascertain that the albumin stood adsorbed on Magnetic Particles 4.

The magnetic particles of the present invention have a good size uniformity and a high safety, and hence can be used as medical-purpose magnetic particles having a low toxicity to living organisms and a high safety and having target directionality to cancer cells, utilizable as MRI contrast media, magnetic hyperthermic agents and DDS carriers.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-236722, filed Aug. 31, 2006, which is hereby incorporated by reference herein in its entirety.

1. Magnetic particles which comprise a magnetic material and a biodegradable polymeric compound;
the magnetic particles having average particle diameter in the range of from 10 nm or more to 1,000 nm or less.

2. The magnetic particles according to claim 1, which have a dispersibility index of 1.5 or less.

3. The magnetic particles according to claim 1, wherein the magnetic material comprises ultrafine magnetic-material particles containing a metallic atom.

4. The magnetic particles according to claim 3, wherein the ultrafine magnetic-material particles comprises a metal oxide.

5. The magnetic particles according to claim 4, wherein the metal oxide is magnetite.

6. The magnetic particles according to claim 5, wherein the magnetite has an average particle diameter of 50 nm or less.

7. The magnetic particles according to claim 1, wherein the biodegradable polymeric compound is an aliphatic polyester.

8. The magnetic particles according to claim 7, wherein the aliphatic polyester is a homopolymer of lactic acid, a hydroxyalkanoic acid or glycolic acid, or a copolymer composed of two or more of any of lactic acid, a hydroxyalkanoic acid and glycolic acid.

9. The magnetic particles according to claim 1, which have on their surfaces a blocking agent for controlling nonspecific adsorption.

10. The magnetic particles according to claim 9, wherein the blocking agent is a compound having a peptide linkage.

11. The magnetic particles according to claim 10, wherein the compound having a peptide linkage is a protein.

12. A process for producing magnetic particles which comprises the steps of:
(1) preparing a liquid mixture containing a biodegradable polymeric compound, a magnetic material and a first solvent;
(2) preparing an emulsion by mixing the liquid mixture with a second solvent; and
(3) removing the first solvent from the emulsion by evaporation or extraction;
the magnetic particles comprising the biodegradable polymeric compound and the magnetic material, having average particle diameter in the range of from 10 nm or more to 1,000 nm or less, and having a dispersibility index of 1.5 or less.

13. The process for producing magnetic particles according to claim 12, wherein the liquid mixture has a viscosity of 20 mPa·s or less.

14. The process for producing magnetic particles according to claim 12, wherein the biodegradable polymeric compound is soluble in the first solvent and slightly soluble in the second solvent.

15. The process for producing magnetic particles according to claim 12, wherein the first solvent is not miscible with the second solvent.

16. The process for producing magnetic particles according to claim 12, wherein a dispersing agent is contained in at least one of the first solvent and the second solvent.

17. The process for producing magnetic particles according to claim 12, wherein the liquid mixture is mixed with the second solvent by emulsification carried out through two-stage operation to prepare the emulsion.
